(19) United States
(12) Patent Application Publication
(10) Pub. No.: US 2024/0124242 A1
(43) Pub. Date: Apr. 18, 2024

(54) Moisture Reducing Roller Conveyor System and Method

(71) Applicant: THE UNIVERSITY OF NEWCASTLE, Callaghan, New South Wales (AU)

(72) Inventors: Kenneth C WILLIAMS, Callaghan (AU); Craig Anthony WHEELER, Callaghan (AU); Michael CARR, Callaghan (AU); Bin CHEN, Callaghan (AU); Jie GUO, Callaghan (AU)

(21) Appl. No.: 18/546,101

(22) PCT Filed: Feb. 10, 2022
(86) PCT No.: PCT/AU2022/050084

§ 371 Date: Aug. 11, 2023

(30) Foreign Application Priority Data
Feb. 12, 2021 (AU) 2021900344

(51) Int. Cl. B65G 23/04

(52) U.S. Cl. CPC B65G 23/04

(57) ABSTRACT

The present invention provides a moisture reduction roller conveyor system (100, 200, 301) and method comprising a continuous carry belt (105, 205, 308) to carry a bulk material and an oscillatory motion assembly (110, 210, 320) operatively connected and configured to induce oscillatory motion of the belt that is transmitted to the bulk material. The oscillatory motion assembly (110) is operatively connected to the frame to induce the oscillatory motion. Alternatively, the oscillatory motion assembly has idler rollers (210a, 210b, 210c) that are offset or eccentric to one another to induce the oscillatory motion. A different oscillatory motion assembly comprises a carriage body (325) for supporting the belt (308) and wheels (340, 345) for engaging a rail track (302). The wheels (340, 345) are configured to induce the oscillatory motion, preferably by periodically lifting one end (360) of the carriage body from the rail track as the carriage moves.

### FIELD OF THE INVENTION

The invention relates to a roller conveyor system implementing an oscillatory moisture reduction system and a carriage for a roller conveyor system for reducing moisture in the transportation of particulate matter. The invention has been developed primarily for use as a moisture reduction system for mineral ore and coal particles on a roller conveyor system and will be described hereinafter by reference to this application. However, it will be appreciated that the invention is capable of application to the transportation of other bulk particulate material, such as powders, flour and grain.

### BACKGROUND OF THE INVENTION

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Mineral ore mining, processing and shipping has increased to record levels over the last decade, especially in relation to iron ore. This has required the development of many new iron ore resources that are mined below the water table or are subjected to wet mineral processing operations. In other cases, the ores are simply mined in high rainfall areas. As a result, many iron and other mineral ores tend to contain a significant component of moisture that needs to be controlled and managed for safe and economic iron or mineral ore production, as well as safe and economic export and transportation.

With respect to iron ore, the iron ore moisture content must be high enough to suppress dust, yet below the level where material handling difficulties occur, and below the Transportable Moisture Limit (TML) for safe shipping. A ship with a cargo that exceeds the TML will not be permitted to leave port, due to the risk of the moisture in the cargo accumulating to one side of the ship in response to wave action and thus capsizing the vessel.

There are also substantial economic benefits to minimising iron ore moisture; although iron ore is sold on a dry tonnage basis, ocean freight is charged per wet tonne of ore shipped. A reduction in moisture therefore reduces the cost of freight. If a mass limited system, such as a railway, is considered to be a bottleneck in the iron ore process chain, then a reduction in moisture can have even greater benefits from an opportunity cost perspective as each tonne of water reduced allows for an additional tonne of iron ore to be railed and sold.

It is an object of the present invention to overcome or substantially ameliorate one or more of the disadvantages of prior art, or at least to provide a useful alternative. It is an object of the invention in at least one preferred form to provide a moisture reduction system for minimising the amount of moisture in bulk loads of mineral ore, especially iron ore or coal.

### SUMMARY OF THE INVENTION

A first aspect of the invention provides a roller conveyor system comprising:
a continuous carry belt to carry a bulk material; and
an oscillatory motion assembly operatively connected to the continuous carry belt;
wherein the oscillatory motion assembly is configured to induce an oscillatory motion of the continuous carry belt that is transmitted to the bulk material.

In some embodiments, the roller conveyor system comprises a plurality of idler rollers for supporting the continuous carry belt, wherein at least one idler roller is mounted to a frame, wherein the oscillatory motion assembly is operatively connected to the frame and the oscillatory motion assembly is configured to induce the oscillatory motion in the frame and the at least one idler roller that is transmitted to the continuous carry belt and bulk material.

In some embodiments, the oscillatory motion assembly comprises one or more actuator arms connected to the frame, a base and a drive mechanism for reciprocating the one or more actuator arms relative to the base. In other embodiments, the drive mechanism comprises a piston assembly. Preferably, the drive mechanism comprises a hydraulic or pneumatic drive mechanism.

In some embodiments, there is a plurality of the actuator arms connected in a linkage arrangement. Preferably, the linkage arrangement is a scissor-type linkage.

In other embodiments, there is a plurality of the actuator arms, the actuator arms being telescopic actuator arms.

In some embodiments, the roller conveyor system comprises a plurality of idler rollers for supporting the continuous carry belt, the plurality of idler rollers being mounted to a frame, wherein two or more idler rollers are configured to induce the oscillatory motion in the continuous carry belt that is transmitted to the bulk material.

In some embodiments, a first idler roller is offset or eccentric to a second idler roller to induce the oscillatory motion. In other embodiments, the first idler roller is offset or eccentric to the second idler roller and a third idler roller to induce the oscillatory motion. In another embodiment, a rotational axis of the first idler roller is offset or eccentric to a rotational axis of the second idler roller and/or a rotational axis of the third idler roller.

In further embodiments, some of the plurality of idler rollers are divided into idler roller sets to induce the oscillatory motion, wherein each idler roller set comprises a first idler roller offset or eccentric to a second idler roller and a third idler roller. In another embodiment, a rotational axis of the first idler roller is offset or eccentric to a rotational axis of the second idler roller and/or a rotational axis of the third idler roller. Preferably, the idler roller sets are arranged in series on the frame.

In some embodiments, the idler roller sets create a corrugated profile in the continuous carry belt.

In some embodiments, the plurality of idler rollers is arranged to create a corrugated profile in the continuous carry belt as it travels over the plurality of idler rollers.

In other embodiments, the idler roller sets or idler rollers define a travel path for the continuous carry belt. Preferably, the travel path is undulating, corrugated or sinusoidal.

In some embodiments, the roller conveyor system comprises a carriage body with a supporting frame for supporting the continuous carry belt and at least three wheels for engaging a rail track, wherein the wheels are configured to induce an oscillatory motion in the carriage body that is transmitted to the continuous carry belt and bulk material as the carriage moves along the rail track.

In some embodiments, the wheels are configured so that, as the carriage moves along the rail track, one end of the carriage body is periodically lifted from the rail track to induce the oscillatory motion.

In some embodiments, the wheels are rotatably connected to the body by a first axle spaced apart from a second axle, and wherein the first axle is offset or eccentric to the second axle to induce movement of the carriage body, producing the oscillatory motion. In other embodiments, the first axle is offset or eccentric to the second axle when viewed in a direction parallel to a longitudinal axis of the carriage body.

In some embodiments, a distance between horizontal planes of the first axle (or centre of the first wheel) and the second axle (or centre of the second wheel) parallel to the rail track is between 10 mm and 50 mm, preferably 15 mm. In other embodiments, the first and second wheels are spaced apart by a distance measured from their respective centres in the range of 200 mm to 1500 mm, preferably 200 mm to 800 mm, and most preferably 300 mm. The diameter of one wheel may preferably be in the range of 50 mm to 300 mm, more preferably 70 mm. The diameter of the other wheel may preferably be in the range of 100 mm to 500 mm, more preferably 140 mm.

In some embodiments, at least one wheel has a different diameter relative to the diameter of another wheel. In other embodiments, the at least one wheel has a smaller diameter than the diameter of another wheel. In further embodiments, the at least one wheel has a larger diameter than the diameter of another wheel.

In some embodiments, the carriage has four wheels arranged in two pairs with each pair of wheels being spaced apart in the longitudinal direction of the carriage body.

In some embodiments, the wheels are flanged and the rail track comprises a pair of rails, the wheels engaging with the pairs of rails.

In some embodiments, the supporting frame has a U-shape with a pair of arms for supporting the sides of the continuous carry belt. In other embodiments, the supporting frame is a yoke.

In some embodiments, the carriage body comprises two supporting frames. In other embodiments, the two supporting frames are arranged on opposite sides of the carriage body. In further embodiments, the supporting frames are arranged on the same side of the carriage body.

In some embodiments, the system comprises a splitter unit for separating the bulk material into a stream of wet bulk material comprising moisture and a stream of dry bulk material. In other embodiments, the splitter unit is located adjacent a discharge end of the roller conveyor system. In further embodiments, the splitter unit is height adjustable relative to the height of the bulk material.

In some embodiments, the continuous carry belt is water permeable to allow moisture to migrate from the bulk material through the continuous carry belt. In other embodiments, the continuous carry belt is porous, perforated or a mesh.

A second aspect of the invention provides a roller conveyor system comprising:
a continuous carry belt to carry a bulk material;
a plurality of idler rollers for supporting the continuous carry belt, wherein at least one idler roller is mounted to a frame; and
an oscillatory motion assembly operatively connected to the frame;
wherein the oscillatory motion assembly is configured to induce an oscillatory motion in the frame and the at least one idler roller that is transmitted to the continuous carry belt and bulk material.

The second aspect may have one or more features of the embodiments of the first aspect of the invention, where applicable.

A third aspect of the invention provides a roller conveyor system comprising:
a continuous carry belt to carry a bulk material; and
a plurality of idler rollers for supporting the continuous carry belt, the plurality of idler rollers being mounted to a frame;
wherein two or more idler rollers are configured to induce an oscillatory motion in the continuous carry belt that is transmitted to the bulk material.

The third aspect may have one or more features of the embodiments of any of the previous aspects of the invention, where applicable.

A fourth aspect of the invention provides a carriage for a roller conveyor system having a continuous carry belt to carry a bulk material, the carriage comprising:
a carriage body with a supporting frame for supporting the continuous carry belt; and
at least three wheels for engaging a rail track;
wherein the wheels are configured to induce an oscillatory motion in the carriage body that is transmitted to the continuous carry belt and bulk material as the carriage moves along the rail track.

The fourth aspect may have one or more features of the embodiments of any of the previous aspects of the invention, where applicable.

A fifth aspect of the invention provides a rail conveyor system comprising a rail track, a plurality of carriages of the third aspect spaced apart from one another and a continuous carry belt supported by the carriages, wherein the carriages are arranged to run on the at least three wheels supported by the track and each carriage is independently supported on the track.

In some embodiments, the continuous carry belt is not fixed to the carriages but is driven directly or indirectly by friction surfaces between the carry belt and the carriages.

In some embodiments, the carriages are connected together by a cable or rope. In other embodiments, the cable or rope is connected to a driving mechanism to move the carriages along the rail track.

In some embodiments, the continuous carry belt is driven by one or more drive belts.

The fifth aspect may have the preferred features of the fourth aspect of the invention stated above, where applicable.

A sixth aspect of the invention provides a method for reducing moisture in a bulk load being transported by a roller conveyor system having a continuous carry belt to carry the bulk material, the method comprising:
supporting the continuous carry belt;
operatively connecting an oscillatory motion assembly to the continuous carry belt; and
inducing an oscillatory motion in the continuous carry belt by the oscillatory motion assembly that is transmitted to the bulk material.

In some embodiments, the continuous carry belt is supported by a plurality of idler rollers, wherein at least one idler roller is mounted to a frame and the oscillatory motion assembly is operatively connected to the frame so that the oscillatory motion assembly induces the oscillatory motion in the frame and the at least one idler roller that is transmitted to the continuous carry belt and bulk material.

In some embodiments, the oscillatory motion is induced by reciprocating one or more actuator arms of the oscillatory motion assembly.

In some embodiments, the continuous carry belt is supported by a plurality of idler rollers mounted to a frame, the method comprising arranging two or more idler rollers to induce the oscillatory motion in the continuous carry belt that is transmitted to the bulk material.

In some embodiments, the method comprises arranging a first idler roller offset or eccentric to a second idler roller to induce the oscillatory motion. In other embodiments, the method comprises arranging the first idler roller offset or eccentric to the second idler roller and a third idler roller to induce the oscillatory motion. In another embodiment, the method comprises arranging the first idler roller so that a rotational axis of the first idler roller is offset or eccentric to a rotational axis of the second idler roller and/or a rotational axis of the third idler roller.

In further embodiments, the method comprises dividing some of the plurality of idler rollers into idler roller sets to induce the oscillatory motion, wherein each idler roller set comprises a first idler roller offset or eccentric to a second idler roller and a third idler roller. In another embodiment, the method comprises arranging a rotational axis of the first idler roller offset or eccentric to a rotational axis of the second idler roller and/or a rotational axis of the third idler roller. Preferably, the method comprises arranging the idler roller sets in series on the frame.

In some embodiments, the method comprises arranging the idler roller sets to create a corrugated profile in the continuous carry belt.

In some embodiments, the method comprises arranging the plurality of idler rollers to create a corrugated profile in the continuous carry belt as it travels over the plurality of idler rollers.

In other embodiments, the method comprises arranging the idler roller sets or idler rollers to define a travel path for the continuous carry belt. Preferably, the travel path is undulating, corrugated or sinusoidal.

In some embodiments, the continuous carry belt is supported by a carriage having at least three wheels for engaging a rail track.

In some embodiments, the roller conveyor system comprises a carriage body with a supporting frame for supporting the continuous carry belt and at least three wheels for engaging a rail track, wherein the method comprises configuring the wheels to induce the oscillatory motion in the carriage body that is transmitted to the continuous carry belt and bulk material as the carriage moves along the rail track.

In some embodiments, the method comprises periodically lifting one end of the carriage from the rail track as the carriage moves along the rail track to induce the oscillatory motion.

In some embodiments, the method comprises rotatably connecting the wheels to the carriage body by a first axle spaced apart from a second axle, and providing the first axle offset or eccentric to the second axle to induce movement of the carriage body, producing the oscillatory motion.

In some embodiments, the method comprises directing the oscillatory motion at an oblique angle to the continuous carry belt.

In some embodiments, the method comprises directing the oscillatory motion substantially transverse or orthogonal to the continuous carry belt.

The sixth aspect may have one or more features of the embodiments of any of the previous aspects of the invention, where applicable.

A seventh aspect of the invention provides a method for reducing moisture in a bulk load being transported by a roller conveyor system having a continuous carry belt to carry the bulk material, the method comprising:
supporting the continuous carry belt by a plurality of idler rollers, wherein at least one idler roller is mounted to a frame; and
inducing an oscillatory motion of the frame and the at least one idler roller that is transmitted to the continuous carry belt and the bulk material.

The seventh aspect may have one or more features of the embodiments of any of the previous aspects of the invention, where applicable.

An eighth aspect of the invention provides a roller conveyor system comprising:
a continuous carry belt to carry a bulk material; and
a plurality of idler rollers for supporting the continuous carry belt, the plurality of idler rollers being mounted to a frame;
wherein two or more idler rollers are configured to induce an oscillatory motion in the continuous carry belt that is transmitted to the bulk material.

The eighth aspect may have one or more features of the embodiments of any of the previous aspects of the invention, where applicable.

A ninth aspect of the invention provides a method for reducing moisture in a bulk load being transported by a roller conveyor system having a continuous carry belt to carry the bulk material, the method comprising:
supporting the continuous carry belt by a frame mounted to a carriage having at least three wheels for engaging a rail track; and
inducing an oscillatory motion of the carriage body that is transmitted to the continuous carry belt and the bulk material;
wherein the at least three wheels are configured to induce the oscillatory movement.

The ninth aspect may have one or more features of the embodiments of any of the previous aspects of the invention, where applicable.

In some embodiments of any of the above aspects of the invention, the frequency of the oscillatory motion is between 2 and 10 Hz. Preferably, the frequency of the oscillatory motion is between 3 and 6 Hz. More preferably, the frequency of the oscillatory motion is between 4 and 6 Hz.

In some embodiments of any of the above aspects of the invention, the method comprises a peak acceleration of the oscillatory motion is between 1 and 10 m/s². Preferably, the peak acceleration of the oscillatory motion is between 4 and 6 m/s². More preferably, the peak acceleration of the oscillatory motion is at least 6 m/s².

In some embodiments of any of the above aspects of the invention, the particle size of the bulk material has a D₅₀ of 0.05 mm to 15 mm, preferably 0.08 mm to 5 mm, more preferably 0.5 mm to 3 mm and most preferably 0.7 mm to 2 mm.

The fifth aspect may have the preferred features of the first and/or second aspects of the invention stated above, where applicable.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a side view of a roller conveyor system according to an embodiment of the invention;

FIG. 2 is a side view of an oscillatory motion assembly that may be used for the roller conveyor system of FIG. 1;

FIG. 3 is a schematic side view of a roller conveyor system according to another embodiment of the invention;

FIG. 4 is a perspective view of a prior art roller conveyor system;

FIG. 5 is a partial perspective view of a similar prior art roller conveyor system;

FIG. 6 is perspective view of a carriage for a roller conveyor system according to one embodiment of the invention;

FIG. 7 is a side view of the carriage of FIG. 6;

FIG. 8 is another side view of the carriage of FIG. 6; and

FIGS. 9 and 10 are graphs illustrating the effect of acceleration on the moisture migration rate.

### PREFERRED EMBODIMENTS OF THE INVENTION

The present invention will now be described with reference to the following examples which should be considered in all respects as illustrative and non-restrictive. In the Figures, corresponding features within the same embodiment or common to different embodiments have been given the same reference numerals.

The present invention may be applied to roller conveyor systems for transporting bulk materials, especially over long distances, and has particular application to the transportation of bulk mineral ore, such as iron ore or coal. Examples of such roller conveyor systems include the Applicant's earlier patent Application Nos. PCT/AU2011/000930, published as WO 2012/009765 A1, and PCT/AU2015/000655, published as WO 2016/065406 A1. The specifications of WO 2012/009765 A1 and WO 2016/065406 A1 are hereby incorporated by reference in their respective entireties.

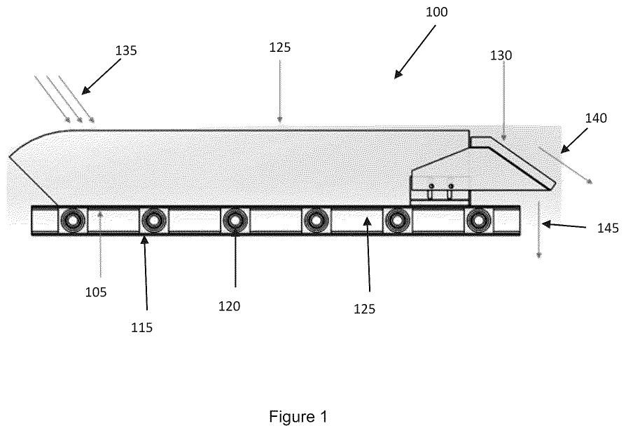

Referring to FIG. 1, a roller conveyor system 100 is shown according to one embodiment of the invention, comprising a continuous carry belt 105 to carry a bulk material and an oscillatory motion assembly 110 operatively connected to the continuous carry belt. The continuous carry belt 105 is supported by a plurality of idler rollers (not shown), which are connected to a frame 115. Wheels or pulleys 120 are placed at regular intervals along the frame 115 to drive the continuous carry belt 105. A cover in the form of a skirting or hood 125 is preferably placed over the continuous carry belt 105 to contain particulates within the system 100. An ore feed stream is fed from one end of the roller conveyor system as shown by the blue arrows 130.

The oscillatory motion assembly 110 is configured to induce an oscillatory motion of the continuous carry belt that is transmitted to the bulk material. This is achieved by the oscillatory motion assembly 110 being operatively connected to the frame 115 and the oscillatory motion assembly configured to induce the oscillatory motion in the frame 115 and the at least one idler roller that is transmitted to the continuous carry belt 105 and bulk material. This oscillatory motion causes the bulk material to shake or vibrate, loosening the particulates within the entire bulk material and releasing the moisture contained therein. This released moisture is then free to migrate towards the bottom or top of the bulk material under the continued vibrations generated by the oscillatory motion. In addition, the oscillatory motion ensures that all of the bulk material is subject to this action, so that the loosening of particulates and release of moisture is uniform across the bulk material. This even distribution of oscillatory motion throughout the bulk material prevents localised pockets of moisture forming within the bulk material.

The released moisture may be removed by various mechanisms. In this embodiment, a divider in the form of an adjustable splitter 135 is arranged at one end of the roller conveyor system 100 to divide the bulk material stream into a “wet” stream 140 and a “dry stream” 145. The wet stream 140 is send to a further dewatering system while the dry stream 145 is ready for transport. Where the moisture migrates to the bottom of the bulk material, the carry belt 105 is preferably water permeable or porous to allow the moisture to flow through the carry belt and be collected beneath by a trough, tray or launder located within the frame 115.

It can thus be observed that operation of the oscillatory motion assembly 110 results in a significant amount of moisture migrating from the bulk material during transportation on the roller conveyor system 100. This ensures that the amount of moisture in the bulk material is reduced to below the TML, and thus it can be safely and efficiently transported by a vessel. In addition, the resulting reduction in the mass of the bulk material means that it now cheaper to transport the bulk material or permit more bulk material to be transported in a vessel than previously possible.

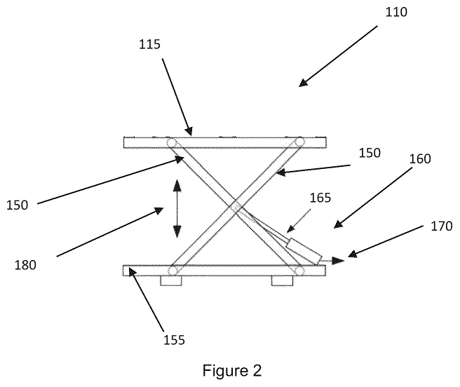

The oscillatory motion assembly 110 may take different forms, but in this embodiment, the oscillatory motion assembly comprises one or more actuator arms 150 connected to the frame 115, a base 155 and a drive mechanism 160 for reciprocating the one or more actuator arms relative to the base, as shown in FIG. 2. In this embodiment, the drive mechanism 160 comprises a piston 165 operatively connected to a hydraulic pack and control system 170. It will be appreciated that the piston 165 may be driven pneumatically and that other types of drive mechanisms may be used, such as electric or fossil fuel motors.

In the actuator arms 150 are connected in a linkage arrangement, in this embodiment, a scissor-type linkage. The piston 165 is connected to the fulcrum or intersection 175 of the actuator arms to reciprocate the actuator arms 150 and induce the oscillatory motion 180 that is transmitted to the frame 115 and idler rollers, passing on to the carry belt 105 and bulk material.

In other embodiments, the actuator arms may be telescopic actuator arms. In this case, there is no need for the scissor-type linkage and each telescopic actuator arm may push the frame 115 up and down in coordination with the other actuator arms to induce the oscillatory motion.

The splitter 135 is height adjustable to relative to the height of the bulk material on the continuous carry belt 105, to ensure that the wet bulk material is correctly separated from the dry bulk material to form the two streams 140, 145. It will be appreciated that in other embodiments, the splitter 135 may be fixed where the proportion of wet bulk material on top of the bulk material is constant.

It will also be appreciated that the oscillatory motion assembly 110 may be a single unit located within the frame 115 under the carry belt 105 or may comprise separate units or individual oscillatory motion assemblies between each wheel 120.

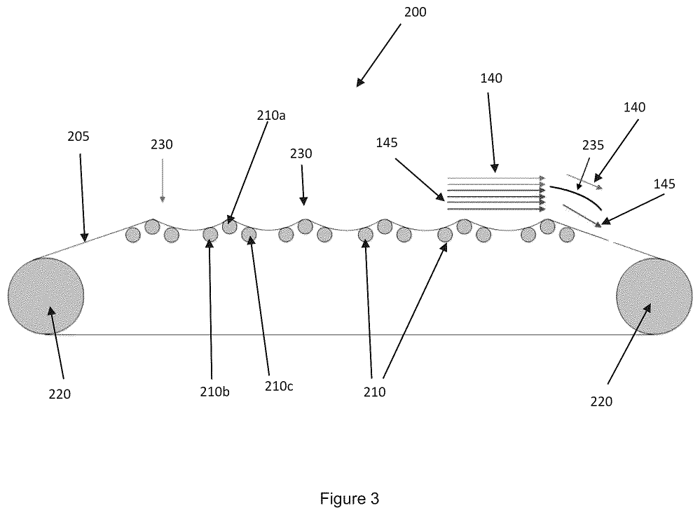

Referring FIG. 3, another roller conveyor system 200 is illustrated according to another embodiment of the invention. In this embodiment, the roller conveyor system 200 comprises a continuous carry belt 205 and a plurality of idler rollers 210 for supporting the continuous carry belt. The plurality of idler rollers 205 are mounted to a frame (not shown). The continuous carry belt 205 is driven by two pulleys 220 at either end.

At least two or more idler rollers 210 are configured to induce the oscillatory motion in the continuous carry belt 205 that is transmitted to the bulk material. In this embodiment, the idler rollers 210 are arranged in sets or groups 230 of three idler rollers. In each idler roller set 230, a first idler roller 210a is offset or eccentric to a second idler roller 210b and a third idler roller 210c. This creates a curve in the carry belt 205, inducing the oscillatory motion to the continuous carry belt 205, and hence the bulk material. The idler roller sets 230 are also arranged in series, creating a corrugated profile in the continuous carry belt 205 as it travels over the plurality of idler rollers 210. In other words, the idler roller sets 230 rollers define a travel path for the continuous carry belt 205 that is preferably undulating, corrugated or sinusoidal, causing a continuous oscillatory motion to be transmitted to the bulk material along the length of the continuous carry belt 205.

This oscillatory motion results in moisture migrating to the top and/or bottom of the bulk material. As in the embodiment of FIGS. 1 and 2, the moisture at the top of the bulk material is removed by dividing the wet stream 140 from the dry stream 145 with an adjustable splitter 240. Moisture that migrates to the bottom of the bulk material passes through the water permeable continuous carry belt 205 for collection as described above.

It will be appreciated that in some embodiments, only a first idler roller is offset or eccentric to a second idler roller to induce the oscillatory motion. In other embodiments, a rotational axis of the first idler roller is offset or eccentric to a rotational axis of the second idler roller and/or a rotational axis of the third idler roller. Moreover, in further embodiments, only some of the idler rollers are arranged into the idler roller sets 230. For example, there may be “standard” idler rollers located between each idler roller set 230. Also, in another embodiment, the idler roller 210a may be positioned below the adjacent idler rollers 210b, 210c, instead of being elevated, to still create the same corrugated or undulating travel path that induces oscillatory motion.

Again, as described in relation to the embodiment of FIGS. 1 and 2, the embodiment of FIG. 3 also reduces the amount of moisture in the bulk material to below the TML for safe transportation and reduces the mass of the bulk material for cheaper and more efficient transportation.

Also, in the first and second embodiments, the oscillatory motion is mostly substantially transverse or orthogonal to the continuous carry belt 105, 205. In this way, the oscillatory motion is substantially orthogonal to the direction of travel of the bulk material on the continuous carry belt 105, 205. In practice, the oscillatory motion is substantially vertical to the horizontal movement of the bulk material. However, it will be appreciated that the oscillatory motion may be directed at an oblique angle to the continuous carry belt and still achieve the necessary disruption of the bulk material to induce moisture migration. It is preferred that the oscillatory motion is substantially transverse or orthogonal to maximise the effect of the vibrations on the bulk material.

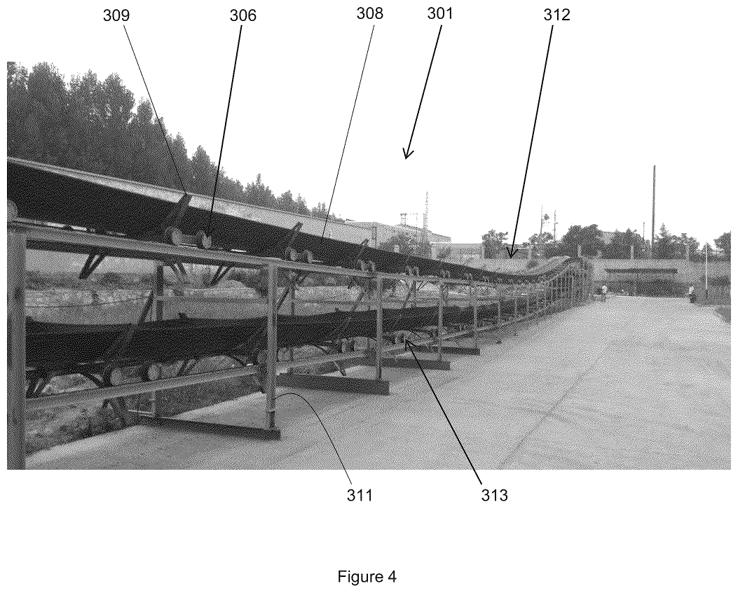

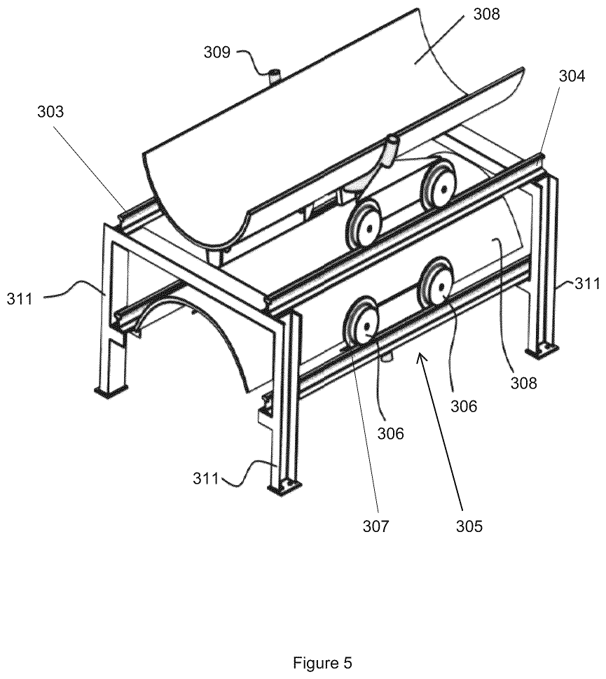

Referring to FIGS. 4 and 5, a prior art roller conveyor system 301 described in PCT/AU2015/000655 is shown to which the invention may be applied. The rail conveyor system 301 has a rail track 302 which typically incorporates two side-by-side conventional rails 303 and 304. These rails may be of a similar type to that used in conventional train rail tracks and may either be mounted on the ground on sleepers as for a conventional rail track system or elevated and supported on frames as is well-known for typical belt conveyor systems.

The roller conveyor system 301 further comprises a plurality of carriages 305 spaced apart from one another and running on wheels 306 supported by the rails 303 and 304 of the rail track 302. The wheels 306 are typically flanged as can be seen at 307 and engage the inside edges of the rails 303 and 304 in a similar manner to a conventional train system. Alternatively, the wheels 306 may be provided with polyurethane lagging or rubber tyres when the roller conveyor system 1 is configured as a monorail type construction.

The rail conveyor system 301 further incorporates a continuous carry belt 308 which is supported by the carriages 305, typically by being carried in a suitably shaped yoke 309 mounted on each carriage.

Although it is possible to connect and drive the carriages 305 solely by their attachment, either by rigid connection or by friction to the carry belt 308, in one preferred form the carriages 305 are spaced apart and connected together by a driving cable or rope 310. The driving rope is typically a steel rope, or ropes driven by drive mechanism (not shown). Alternatively, the rope 310 may serve to simply connect the carriages 305 and the carriages may be driven by tension in the conveyor belt 830 driven in a more conventional manner.

The rails 303 and 304 may be supported in many different ways, and FIG. 4 shows one example of supporting the rails on spaced apart frames 311 or on pylons as is common with conventional belt conveyors. One particularly cost effective method of constructing the conveyor is to locate the conveying run 312 above the return run 313, as shown in FIGS. 4 and 5. FIG. 4 shows the carry belt supported by the carriages 305 in an “upright” configuration, while FIG. 5 shows the carry belt supported by the carriages in an inverted or upside down configuration in the return 313. Alternatively, the conveying run 312 may be located side-by-side with or parallel to the return run 313, the two runs of rails being supported on a set of common sleepers in a manner similar to a convention railway system, elevated on a series of columns or pylons and transverse cross beams or on a monorail type construction.

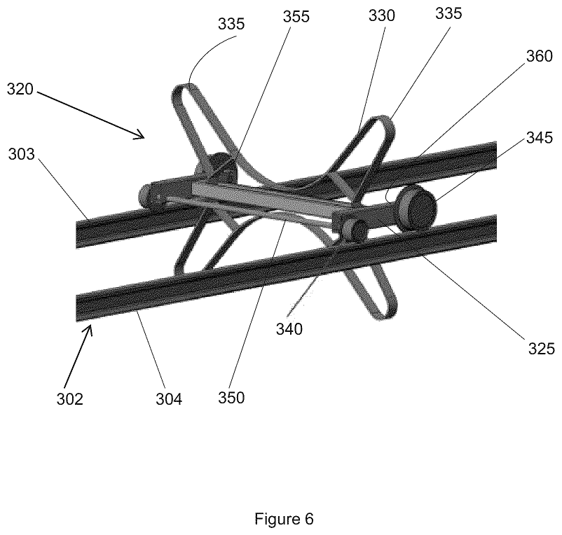

Referring to FIGS. 6 to 8, a preferred embodiment of the invention is shown for use in the roller conveyor system 301. The carriage 320 is intended to replace the carriages 305 and provides a moisture reduction system to lower the TML of bulk materials on the carry belt 308.

The carriage 320 has a carriage body 325, supporting frames for supporting the continuous carry belt 308 in the form of a yoke 330 with a pair of yoke arms 335 arranged on opposite sides of the carriage body 325. The carriage 320 also has two pairs of wheels 340, 345 for engaging the rail track 302, which in this embodiment are flanged at 307 to engage the rails 303, 304 of the rail track. The wheels 340, 345 are configured to induce an oscillatory motion in the carriage body 325 that is transmitted to the continuous carry belt 308 and bulk material as the carriage 320 moves along the rail track 302.

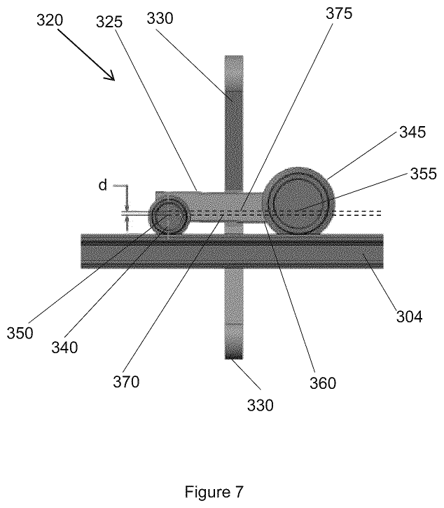

In this embodiment, the oscillatory motion is produced by the wheel configuration of the carriage 320. More specifically, the wheels 340, 345 have axles 350, 355 offset or eccentric relative to each other, as best shown in FIG. 7. While the front wheels 340 share a common axle 350, the rear wheels 355 have their own separate axles 355. The offset or eccentricity of the axles 350, 355 is determined from the view in a direction parallel to a longitudinal axis of the carriage 320. This offset configuration of the axles 350, 355 causes the rear wheels 345 to lift up the carriage 320 as it moves along the rails 303, 304 of the rail track 302. Effectively, the rear wheels 345 act like eccentric wheels due to the eccentric configuration of the front axle 350 and rear axle 355. As a consequence, the rear end 360 of the carriage body 325 also begins to lift, pivoting the carriage body 325 about the axle 345 of the front wheels 340 and lifting the yoke 330, and hence the continuous carry belt 308 and the bulk material being transported. As the carriage 320 continues to travel along the rail track 302, the rear wheels 345 rotate and the rear end 360 is lowered. In this manner, the carriage body 325 is periodically lifted and lowered as the rear wheels 345 rotate and the carriage 320 moves to induce the oscillatory motion. This periodic oscillatory motion is thus transmitted to the carriage body 325, yoke 330, carry belt 308 and bulk material.

The oscillatory motion travels through the bulk material held by the carry belt 308 above the carriage 320, effectively vibrating or shaking the bulk material, loosening the particulates within and releasing the moisture contained therein. This released moisture is then free to migrate towards the bottom or top of the bulk material under the continued vibrations generated by the oscillatory motion, where it may be removed by various mechanisms. For example, where the moisture migrates to the bottom of the bulk material, the carry belt 308 is porous to allow the moisture to flow through the carry belt and collected beneath by a trough or tray located below the rail track 302. Where the moisture migrates to the top of the bulk material, an adjustable splitter may be used to remove this moisture as described above.

This moisture releasing effect of the oscillatory motion on the bulk material is repeated for each carriage 320 in the roller conveyor system 301. Hence, in operation, the bulk material is continuously subjected to vibration from the oscillatory motion as it travels along the length of the continuous carry belt 308. Consequently, a significant amount of moisture migrates from the bulk material during transportation on the roller conveyor. This ensures that the amount of moisture in the bulk material is reduced to below the TML, and thus it can be safely and efficiently transported by a vessel. In addition, the resulting reduction in the mass of the bulk material means that it now cheaper to transport the bulk material or permit more bulk material to be transported in a vessel than previously possible.

As with the first and second embodiments, in this embodiment, the oscillatory motion is mostly substantially transverse or orthogonal to the continuous carry belt 308. In this way, the oscillatory motion is substantially orthogonal to the direction of travel of the bulk material on the continuous carry belt 308. In practice, the oscillatory motion is substantially vertical to the horizontal movement of the bulk material, but may be directed at an oblique angle to the continuous carry belt and still achieve the necessary disruption of the bulk material to induce moisture migration. It is also preferred that the oscillatory motion is substantially transverse or orthogonal to maximise the effect of the vibrations on the bulk material.

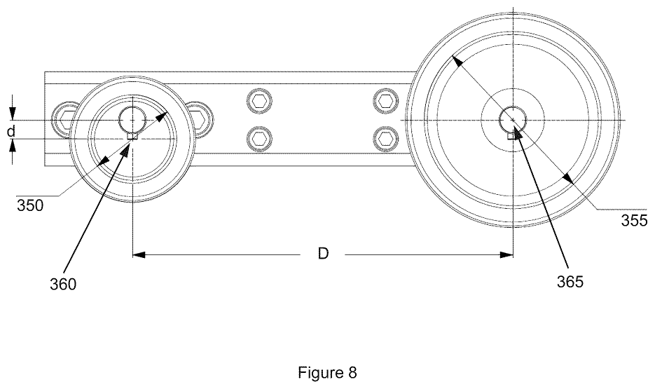

The amount of offset between the axles 350 and 355 is relatively small. As best shown in FIG. 7, the offset is determined by measuring the distance or gap d between horizontal planes 370, 375 respectively intersecting the longitudinal axes 380, 385 of the axles 350, 355, the horizontal planes 370, 375 being parallel to the rail track 302. This distance d is dependent on the diameters 350, 355 of wheels 340, 345 but is sufficient to generate the necessary oscillatory motion in the carriage for transmission to the bulk material via the carry belt 308. In this embodiment, as best shown in FIG. 8, the front wheel 340 has a diameter of 70 mm and the rear wheel 345 has a diameter 355 of 140 mm, with the distance d being 15 mm, for the roller conveyor system operating at 1,500 tonnes/hr dewatering iron ore. The wheels 340, 345 are also spaced apart by distance D, which in this case is 300 mm, measured from their respective centres 360, 365. In other embodiments, the distance d may range between 10 mm to 50 mm. Similarly, the front wheel 340 diameters 350 may be in the range of 50 mm to 300 mm. The rear wheel 345 diameters 355 may be in the range of 100 mm to 500 mm. The wheels 340, 345 may also be spaced apart in the range of 200 mm to 800 mm, measured from their respective centres 360, 365. It will be appreciated that these diameters and distances may vary depending on the load carried by the continuous carry belt and the throughput (tonnes/hr), as well as the different types of carriages that may be used in a variety of systems. For example, the distance D between the front and rear wheels may vary depending on the type of carriage used, from at least 200 mm up to 1,500 mm or even 2000 mm.

The generation of the oscillatory motion is further assisted by the wheels 340, 345 having different diameters 350, 355, respectively. In the embodiment, the front wheels 340 have a smaller diameter 350 than the diameter 355 of the rear wheels 345. It will also be appreciated that while the carriage 320 has been described with the front wheels 340 having a smaller diameter to the rear wheels 345, the reverse configuration is equally effective; that is, the front wheels 340 may have a larger diameter relative to the rear wheels 345.

In this embodiment, the amplitude of the oscillatory motion is relatively small, in the range of 10 mm to 80 mm, more preferably in the range of 12 mm to 76 mm, and most preferably around 25 mm. It has also been discovered that the peak acceleration and/or frequency of the oscillatory motion influences the amount of moisture migration that may be achieved. It has been determined that it is preferable that the peak acceleration of the oscillatory motion is between 1 and 10 m/s², and more preferably, between 4 and 6 m/s². Similarly, the frequency of the oscillatory motion is between 2 and 10 Hz, more preferably, between 3 and 6 Hz and most preferably, between 4 and 6 Hz. The influence of these factors is demonstrated in the example described below.

### EXAMPLES

Different types of ore samples were taken from two sites and labelled as ore samples A to D and F to I, with ore samples A to D from one site and ore samples F to I from another site (ore sample E was used for calibration purposes only). Ore samples A, C and D were iron ore fines; ore sample B was concentrated iron ore; ore sample F was an iron ore lump sample; ore sample G was a laboratory prepared sample; and iron ore samples H and I were iron ore fines.

The ore samples had the characteristics listed in Table 1 below.

TABLE 1
Ore Sample Characteristics Summary

| | | | Rosin | Solid | | Moisture | U [symbol] N Free | |
|---|---|---|---|---|---|---|---|---|
| | | Rosin | Rammler | Particle | | When | Drain | |
| Ore | D₅₀ | Rammler | Uniformity | Density | Particle | Pores | Saturation | Free |
| Type | (mm) | d (mm) | n | (t/m³) | Porosity | Saturated | Moisture | Water |
| A | 3 | 5.74 | 1.0813 | 4.797 | 19.6% | 5.20% | 11.80% | 6.60% |
| B | 0.084 | 0.08 | 1.9769 | 5.136 | 5.4% | 1.18% | 15.78% | 14.60% |
| C | 0.71 | 1.46 | 1.1511 | 4.711 | 14.4% | 3.80% | 12.00% | 8.20% |
| D | 0.71 | 1.37 | 0.8751 | 4.593 | 23.1% | 6.97% | 10.87% | 3.90% |
| F | 15 | 15.21 | 3.3930 | 4.154 | — | — | 4.90% | — |
| G | 2 | 3.21 | 0.9132 | 4.268 | 13.5% | 3.80% | 6.80% | 3.00% |
| coarse | | | | | | | | |
| G fine | 0.25 | 0.58 | 0.9132 | 4.453 | 11.3% | 3.00% | 19.80% | 16.80% |
| H | 2.8 | 2.82 | 3.9230 | 4.556 | 17.5% | 5.00% | 13.30% | 8.30% |
| I | 5 | 8.37 | 0.9132 | 4.239 | 13.2% | 3.80% | 8.30% | 4.20% |

[symbol]

indicates data missing or illegible when filed

As understood by one skilled in the art, the D₅₀ measurement means that 50% of all particles present will pass through a nominated screen mesh size. For example, a D₅₀=500 μm means that 50% of all particles present will pass through a 500 μm screen aperture. Hence, the D₅₀ provides an indication of the particle size distribution. In this case, for example, the D₅₀ of the ore sample A is 3 mm means that 50% of the particles present will pass through screen having apertures 3 mm in diameter.

The ore samples were each divided into six material columns with water collectors beneath each column. A load cell was positioned beneath each water collector used to monitor and record the change in water mass within the water collector. The ore sample columns were collectively subjected to the same oscillatory motion according to the principles of the invention over the range of accelerations, frequencies and amplitudes in Table 2 below.

TABLE 2
Acceleration, Frequency and Amplitude
for Test Oscillatory Motions

| Acceleration (m/s²) | Frequency (Hz) | Peak to Peak Amplitude (mm) |
|---|---|---|
| 4 | 2 | 51.0 |
| 4 | 4 | 12.7 |
| 6 | 2 | 76.0 |

Tables 3 to 10 below show the results of moisture reduction in each ore sample subjected to the above acceleration, frequency and amplitude parameters. In the results below, to take into account the different origination of the ore samples, the initial moisture content was defined as X, where that value different for each site, and an example moisture content of X+3% means a value of X plus 3% of X.

Also, in Tables 3 to 10, the moisture migration mode describes whether moisture migrated towards the top or bottom of the column; the total moisture reduction is the amount of moisture that was lost from the ore sample; the compaction means the percentage by which the sample reduced in volume; the ultra-fines migration mode describes whether moisture migrated towards the top or bottom of the column for ultra-fine particles of ˜45 μm; the ultra-fines Max. Diff. describes the maximum difference for ultra-fine particles of ˜45 μm amongst the load cells for the six columns; and the moisture migration rate was measured in terms of grams per oscillation cycle.

TABLE 3
Moisture Migration Results for Ore Sample A
Ore A

| | | | | | | |
|---|---|---|---|---|---|---|
| | | | | | | Moisture |
| Initial | Moisture | | | Ultra-fines | | Migration |
| Mositure | Migration | Total Moisture | | Migration | Ultra-fines | Rate |
| Content | Mode | Reduction | Compaction | Mode | Max. Diff. | (g/cycle) |

Motion 1: Acceleration 4 m/s² Frequency 2 Hz

| | | | | | | |
|---|---|---|---|---|---|---|
| X + [symbol] % | Bottom | 0.04% | 5% | NA | 0.35% | 3.80E−04 |
| X + [symbol] % | Bottom | 0.1% | 5% | NA | 3.25% | 1.41E−03 |
| X + 10% | Bottom | 0.6% | 1% | NA | 5.44% | 5.69E−03 |

Motion 2: Acceleration 4 m/s² Frequency 4 Hz

| | | | | | | |
|---|---|---|---|---|---|---|
| X + [symbol] % | Bottom | 0% | 7% | NA | 7.3% | NA |
| X + [symbol] % | Bottom | 0.05% | 18% | NA | 5.43% | NA |
| X + 10% | Bottom | 1% | 8% | NA | 6.42% | NA |

Motion 3: Acceleration 6 m/s² Frequency 2 Hz

| | | | | | | |
|---|---|---|---|---|---|---|
| X + [symbol] % | Bottom | 0.02% | 20% | NA | 6.05% | 1.26E−03 |
| X + [symbol] % | Top | 1.1% | 27% | NA | 17.72% | 9.78E−03 |
| X + 10% | Top | 3.2% | 15% | NA | 13.47% | 1.87E−02 |

[symbol]

indicates data missing or illegible when filed

TABLE 4
Moisture Migration Results for Ore Sample B
Ore B

| | | | | | | |
|---|---|---|---|---|---|---|
| | | | | | | Moisture |
| Initial | Moisture | | | Ultra-fines | | Migration |
| Mositure | Migration | Total Moisture | | Migration | Ultra-fines | Rate |
| Content | Mode | Reduction | Compaction | Mode | Max. Diff. | (g/cycle) |

Motion 1: Acceleration 4 m/s² Frequency 2 Hz

| | | | | | | |
|---|---|---|---|---|---|---|
| X + [symbol] % | Bottom | 0.08% | 9% | NA | 3.7% | 7.14E−04 |
| X + [symbol] % | Bottom | 0.16% | 12% | NA | 3.44% | 1.33E−03 |
| X + 10.5% | Bottom | 0.2% | 21% | NA | 1.63% | 2.25E−03 |

Motion 2: Acceleration 4 m/s² Frequency 4 Hz

| | | | | | | |
|---|---|---|---|---|---|---|
| X + [symbol] % | Bottom | 0.02% | 10% | NA | 4.45% | NA |
| X + [symbol] % | Bottom | 0.16% | 13% | NA | 4.16% | NA |
| X + 10.5% | Bottom | 0.2% | 18% | NA | 3.14% | NA |

Motion 3: Acceleration 6 m/s² Frequency 2 Hz

| | | | | | | |
|---|---|---|---|---|---|---|
| X + [symbol] % | Bottom | 0.08% | 15% | NA | 1.10% | 8.28E−04 |
| X + [symbol] % | Bottom | 1.14% | 21% | NA | 2.02% | 2.03E−03 |
| X + 10.5% | Bottom | 0.1% | 27% | NA | 7.11% | 4.25E−03 |

[symbol]

indicates data missing or illegible when filed

TABLE 5
Moisture Migration Results for Ore Sample C
Ore C

| | | | | | | |
|---|---|---|---|---|---|---|
| | | | | | | Moisture |
| Initial | Moisture | | | Ultra-fines | | Migration |
| Mositure | Migration | Total Moisture | | Migration | Ultra-fines | Rate |
| Content | Mode | Reduction | Compaction | Mode | Max. Diff. | (g/cycle) |

Motion 1: Acceleration 4 m/s² Frequency 2 Hz

| | | | | | | |
|---|---|---|---|---|---|---|
| X + 5.5% | Bottom | 0.1% | 27% | NA | 0.29% | 8.74E−04 |
| X + 7% | Bottom | 0.3% | 21% | NA | 0.17% | 1.88E−03 |
| X + 8.5% | Bottom | 1.2% | 20% | NA | 0.62% | 6.25E−03 |

Motion 2: Acceleration 4 m/s² Frequency 4 Hz

| | | | | | | |
|---|---|---|---|---|---|---|
| X + 5.5% | Bottom | 0.15% | 24% | NA | 1.42% | NA |
| X + 7% | Bottom | 0.25% | 23% | NA | 0.55% | NA |
| X + 8.5% | Bottom | 1.3% | 28% | NA | 0.53% | NA |

Motion 3: Acceleration 6 m/s² Frequency 2 Hz

| | | | | | | |
|---|---|---|---|---|---|---|
| X + 5.5% | Bottom | 0.12% | 23% | NA | 1.14% | 2.40E−03 |
| X + 7% | Bottom | 0.25% | 26% | NA | 0.39% | 8.48E−03 |
| X + 8.5% | Bottom | 2% | 26% | NA | 0.50% | 1.63E−02 |

TABLE 6
Moisture Migration Results for Ore Sample D
Ore D

| | | | | | | |
|---|---|---|---|---|---|---|
| | | | | | | Moisture |
| Initial | Moisture | | | Ultra-fines | | Migration |
| Mositure | Migration | Total Moisture | | Migration | Ultra-fines | Rate |
| Content | Mode | Reduction | Compaction | Mode | Max. Diff. | (g/cycle) |

Motion 1: Acceleration 4 m/s² Frequency 2 Hz

| | | | | | | |
|---|---|---|---|---|---|---|
| X + [symbol] % | Bottom | 0.08% | 15% | NA | 4.28% | 9.58E−04 |
| X + [symbol] % | Bottom | 0.05% | 23% | NA | 3.88% | 1.60E−03 |
| X + [symbol] % | Bottom | 0.37% | 25% | NA | 2.37% | 4.76E−03 |

Motion 2: Acceleration 4 m/s² Frequency 4 Hz

| | | | | | | |
|---|---|---|---|---|---|---|
| X + [symbol] % | Bottom | 0.04% | 12% | NA | 5.41% | NA |
| X + [symbol] % | Bottom | 0.2% | 18% | down | 6.04% | NA |
| X + [symbol] % | Bottom | 0.9% | 17% | up | 10.81% | NA |

Motion 3: Acceleration 6 m/s² Frequency 2 Hz

| | | | | | | |
|---|---|---|---|---|---|---|
| X + [symbol] % | Bottom | 0.08% | 10% | NA | 2.04% | 1.05E−03 |
| X + [symbol] % | Top | 0.02% | 25% | NA | 5.05% | 4.46E−03 |
| X + [symbol] % | Top | 1.3% | 25% | up | 8.05% | 2.00E−02 |

[symbol]

indicates data missing or illegible when filed

TABLE 7
Moisture Migration Results for Ore Sample F
Ore F

| | | | | | | |
|---|---|---|---|---|---|---|
| | | | | | | Moisture |
| Initial | Moisture | | | Ultra-fines | | Migration |
| Mositure | Migration | Total Moisture | | Migration | Ultra-fines | Rate |
| Content | Mode | Reduction | Compaction | Mode | Max. Diff. | (g/cycle) |

Motion 1: Acceleration 4 m/s² Frequency 2 Hz

| | | | | | | |
|---|---|---|---|---|---|---|
| X + 1.5% | NA | 0% | 0% | NA | NA | 1.67E−04 |
| X + 2.5% | NA | 0% | 0% | NA | NA | 3.64E−04 |
| X + 4% | NA | 0% | 0% | NA | NA | 7.76E−04 |

Motion 2: Acceleration 4 m/s² Frequency 4 Hz

| | | | | | | |
|---|---|---|---|---|---|---|
| X + 1.5% | NA | 0% | 4% | NA | NA | NA |
| X + 2.5% | NA | 0% | 5% | NA | NA | NA |
| X + 4% | Top | 0.02% | 5% | NA | NA | NA |

Motion 3: Acceleration 6 m/s² Frequency 2 Hz

| | | | | | | |
|---|---|---|---|---|---|---|
| X + 1.5% | NA | 0% | 14% | NA | NA | 7.06E−04 |
| X + 2.5% | NA | 0% | 12% | NA | NA | 9.69E−04 |
| X + 4% | NA | 0% | 16% | NA | NA | 1.49E−03 |

TABLE 8
Moisture Migration Results for Ore Sample G
Ore G

| | | | | | | |
|---|---|---|---|---|---|---|
| | | | | | | Moisture |
| Initial | Moisture | | | Ultra-fines | | Migration |
| Mositure | Migration | Total Moisture | | Migration | Ultra-fines | Rate |
| Content | Mode | Reduction | Compaction | Mode | Max. Diff. | (g/cycle) |

Motion 1: Acceleration 4 m/s² Frequency 2 Hz

| | | | | | | |
|---|---|---|---|---|---|---|
| X + [symbol] % | Bottom | 0.03% | 18% | NA | 1.22% | 4.95E−04 |
| X + [symbol] % | Bottom | 0.26% | 22% | NA | 1.08% | 2.37E−03 |
| X + [symbol] % | Bottom | 1.1% | 20% | NA | 1.63% | 8.36E−03 |

Motion 2: Acceleration 4 m/s² Frequency 4 Hz

| | | | | | | |
|---|---|---|---|---|---|---|
| X + [symbol] % | Bottom | 0.03% | 23% | NA | 1.81% | NA |
| X + [symbol] % | Bottom | 0.12% | 22% | NA | 1.35% | NA |
| X + [symbol] % | Bottom | 1% | 25% | NA | 1.63% | NA |

Motion 3: Acceleration 6 m/s² Frequency 2 Hz

| | | | | | | |
|---|---|---|---|---|---|---|
| X + [symbol] % | NA | 0% | 23% | NA | 1.35% | 7.40E−03 |
| X + [symbol] % | Bottom | 0.25% | 23% | NA | 1.21% | 5.80E−03 |
| X + [symbol] % | Bottom | 1.1% | 24% | NA | 1.63% | 1.71E−02 |

[symbol]

indicates data missing or illegible when filed

TABLE 9
Moisture Migration Results for Ore Sample H
Ore H

| | | | | | | |
|---|---|---|---|---|---|---|
| | | | | | | Moisture |
| Initial | Moisture | | | Ultra-fines | | Migration |
| Mositure | Migration | Total Moisture | | Migration | Ultra-fines | Rate |
| Content | Mode | Reduction | Compaction | Mode | Max. Diff. | (g/cycle) |

Motion 1: Acceleration 4 m/s² Frequency 2 Hz

| | | | | | | |
|---|---|---|---|---|---|---|
| X + [symbol] % | NA | 0% | 10% | NA | 0.05% | 3.56E−03 |
| X + [symbol] % | Bottom | 0.36% | 10% | NA | 0% | 7.46E−03 |
| X + 12% | Bottom | 2% | 7% | NA | 0% | 1.75E−02 |

Motion 2: Acceleration 4 m/s² Frequency 4 Hz

| | | | | | | |
|---|---|---|---|---|---|---|
| X + [symbol] % | NA | 0% | 14% | NA | 0.05% | NA |
| X + [symbol] % | Bottom | 0.6% | 9% | NA | 0.05% | NA |
| X + 12% | Bottom | 1.6% | 8% | NA | 0.04% | NA |

Motion 3: Acceleration 6 m/s² Frequency 2 Hz

| | | | | | | |
|---|---|---|---|---|---|---|
| X + [symbol] % | NA | 0% | 14% | NA | 0.05% | 4.56E−03 |
| X + [symbol] % | Bottom | 0.6% | 13% | NA | 0.07% | 1.05E−02 |
| X + 12% | Bottom | 1.8% | 9% | NA | 0.07% | 2.57E−02 |

[symbol]

indicates data missing or illegible when filed

TABLE 10
Moisture Migration Results for Ore Sample I
Ore I

| | | | | | | |
|---|---|---|---|---|---|---|
| | | | | | | Moisture |
| Initial | Moisture | | | Ultra-fines | | Migration |
| Mositure | Migration | Total Moisture | | Migration | Ultra-fines | Rate |
| Content | Mode | Reduction | Compaction | Mode | Max. Diff. | (g/cycle) |

Motion 1: Acceleration 4 m/s² Frequency 2 Hz

| | | | | | | |
|---|---|---|---|---|---|---|
| X + [symbol] % | Bottom | 0.05% | 11% | NA | 0.03% | 5.38E−04 |
| X + [symbol] % | Bottom | 2.4% | 9% | NA | 0.06% | 1.58E−02 |
| X + 12% | Bottom | 5.8% | 8% | NA | 0.03% | 2.77E−02 |

Motion 2: Acceleration 4 m/s² Frequency 4 Hz

| | | | | | | |
|---|---|---|---|---|---|---|
| X + [symbol] % | NA | 0% | 13% | NA | 1.03% | NA |
| X + [symbol] % | Bottom | 1.5% | 10% | NA | 1.04% | NA |
| X + 12% | Bottom | 3.6% | 11% | NA | 1.04% | NA |

Motion 3: Acceleration 6 m/s² Frequency 2 Hz

| | | | | | | |
|---|---|---|---|---|---|---|
| X + [symbol] % | NA | 0% | 12% | NA | 1.03% | 4.79E−03 |
| X + [symbol] % | Bottom | 1.2% | 12% | NA | 1.01% | 9.33E−03 |
| X + 12% | Bottom | 5% | 11% | NA | 1.02% | 2.68E−02 |

[symbol]

indicates data missing or illegible when filed

It can be observed from the results in Tables 3 to 10 that the acceleration rate appeared to have greater influence than the frequency in affecting the moisture migration rate, although significant reductions in moisture were achieved for the tested acceleration and frequency parameters, indicating that they contributed to the overall moisture reduction rate.

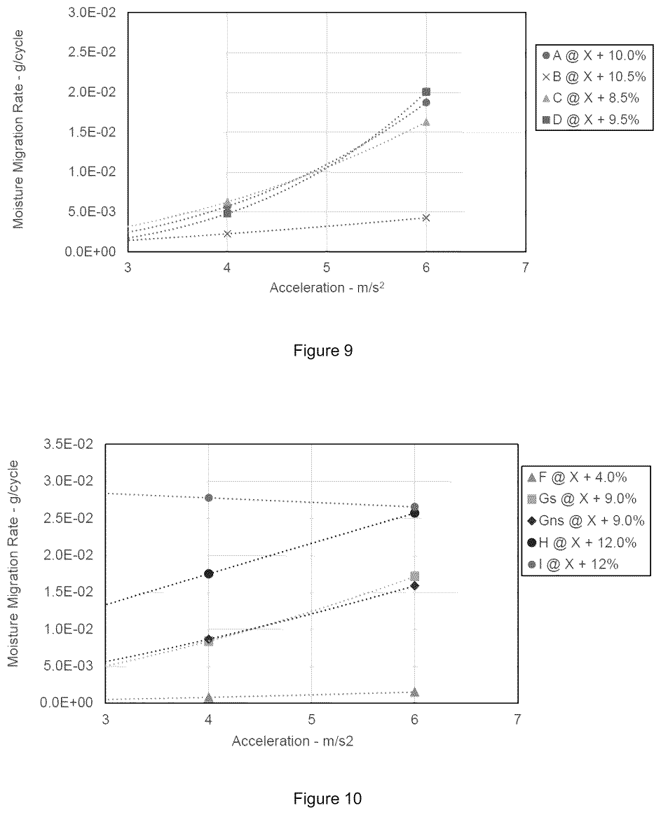

FIG. 9 is a graph showing the moisture migration rate plotted against the acceleration rate for ore samples A to D, whereas FIG. 10 is a graph showing the moisture migration rate plotted against the acceleration rate for ore samples F to I. Both graphs demonstrate that the moisture migration rates increase as the acceleration rates increases. Hence, the examples demonstrate the effectiveness of the preferred embodiment of the invention in reducing moisture in bulk material being transported by the roller conveyor system 1.

While in the described embodiment there are four wheels 340, 345 for the carriage 320, it will be appreciated that the invention may be implemented with at least three wheels for engaging the rail track. In this instance, a single wheel may be located at the front or rear of the carriage 320 and a pair of wheels at the rear or front, respectively, while the rail track 302 may include a further rail for engaging the single wheel. In this arrangement, the effect on the carriage 320 is the same; the carriage body 325 is periodically raised and lowered as the wheels rotate and the carriage moves along the rail track 302, inducing the oscillatory motion that is imparted to the carry belt 308 and hence the bulk material.

In some embodiments, the offset wheel configuration may be replaced with a scissor-type lifting mechanism to produce the necessary oscillatory motion. This scissor-type lifting mechanism may be hydraulically or pneumatically operated. However, it is contemplated that this embodiment would be difficult to operate and maintain for roller conveyor systems over long distances, as well as requiring a power source for the hydraulic or pneumatic systems for operate the scissor arms, increasing capital, operating and maintenance costs. Consequently, it is believed that the offset wheel configuration is more cost-effective as it relies on a simpler mechanism to generate the oscillatory motion without requiring a separate power source or significant maintenance.

In some embodiments, the carriage body comprises a single supporting frame. In other embodiments, there are multiple supporting frames. In further embodiments, the supporting frames are arranged on the same side of the carriage body. It is contemplated that the supporting frame provide multiple contact points for transmitting the oscillatory motion generated by the wheels 340, 345 to further enhance the vibrations that disrupt the bulk material, further increasing the amount of moisture migration.

It will further be appreciated that any of the features in the preferred embodiments of the invention can be combined together and are not necessarily applied in isolation from each other. For example, the carriage 320 of FIGS. 3 and 4 can be modified to have multiple yokes 330 along the carriage body 325 on top and bottom sides. As another example, the axles 350, 355 can be individual axles for each wheel 340, 345 or a common axle for both wheels 340, 345. Likewise, the invention may also be implemented by having eccentric axles for the wheels without having wheels of different diameters. Similar combinations or variations of two or more features from the above described embodiments or preferred forms of the invention can be readily made by one skilled in the art.

By providing an oscillatory motion assembly (such as reciprocating actuator arms, eccentric idler rollers and wheel configuration for carriages) to induce oscillatory motion to a continuous carry belt in a roller conveyor system for transporting bulk material, the invention confers the advantages of continuously subjecting the bulk material to vibrations from the oscillatory motion, causing moisture to migrate from the bulk material for removal. This in turn results in the bulk material having a moisture content below the TML, ensuring that the bulk material may be safely and efficiently transported by a vessel, such as a cargo ship. In addition, the reduction in moisture content reduces the mass of the bulk material, rendering its transportation cheaper and more efficient. It also means that more bulk material can be transported in a vessel due to the reduction in its overall mass. These advantages are further enhanced by adopting reciprocating actuator arms, an offset or eccentric idler roller configuration or wheel axle configuration that produce the required oscillatory motion simply and effectively without increasing capital, operation or maintenance costs compared to other system. Furthermore, since the invention only requires minimal addition of the oscillatory motion assembly (or replacement of the idler rollers or carriages) to a roller conveyor system, the invention can be readily implemented to existing roller conveyor systems. In all these respects, the invention represents a practical and commercially significant improvement over the prior art.

Although the invention has been described with reference to specific examples, it will be appreciated by those skilled in the art that the invention may be embodied in many other forms.

1. A roller conveyor system comprising:
a continuous carry belt to carry a bulk material; and
a plurality of idler rollers for supporting the continuous carry belt, the plurality of idler rollers being mounted to a frame;
wherein two or more idler rollers are configured to induce an oscillatory motion of the continuous carry belt that is transmitted to the bulk material.

2. The system of claim 1, wherein a first idler roller is offset or eccentric to a second idler roller to induce the oscillatory motion.

3. The system of claim 1, wherein some of the plurality of idler rollers are divided into idler roller sets to induce the oscillatory motion, wherein each idler roller set comprises a first idler roller offset or eccentric to a second idler roller and a third idler roller.

4. The system of claim 2, wherein the idler rollers define a travel path, preferably undulating, corrugated or sinusoidal, for the continuous carry belt.

5. A carriage for a roller conveyor system having a continuous carry belt to carry a bulk material, the carriage comprising:
a carriage body with a supporting frame for supporting the continuous carry belt; and
at least three wheels for engaging a rail track;
wherein the wheels are configured to induce an oscillatory motion in the carriage body that is transmitted to the continuous carry belt and bulk material as the carriage moves along the rail track.

6. The carriage of claim 5, wherein the wheels are configured so that, as the carriage moves along the rail track, one end of the carriage body is periodically lifted from the rail track to induce the oscillatory motion.

7. The carriage of claim 5, wherein the wheels are rotatably connected to the body by a first axle and a second axle, wherein the first axle is spaced apart from the second axle, and wherein the first axle is offset or eccentric to the second axle to induce movement of the carriage body, producing the oscillatory motion.

8. The carriage of claim 5, wherein at least one wheel has a different diameter relative to the diameter of another wheel.

9. A roller conveyor system comprising a continuous carry belt to carry a bulk material, a rail track and a plurality of carriages according to claim 5, wherein the carriages run on the rail track and support the continuous carry belt.

10. The system of claim 1 or 9, wherein the oscillatory motion is at an oblique angle to the continuous carry belt or substantially transverse or orthogonal to the continuous carry belt.

11. The system of claim 1 or 9, wherein the frequency of the oscillatory motion is between 2 and 10 Hz, preferably between 3 and 6 Hz, and most preferably between 4 and 6 Hz.

12. The system of claim 1 or 9, wherein a peak acceleration of the oscillatory motion is between 1 and 10 m/s², preferably between 4 and 6 m/s², and most preferably at least 6 m/s².

13. (canceled)

14. The method of claim 22, further comprising dividing some of the plurality of idler rollers into idler roller sets to induce the oscillatory motion, wherein each idler roller set comprises a first idler roller offset or eccentric to a second idler roller and a third idler roller.

15. The method of claim 22, further comprising arranging the idler rollers to define a travel path, preferably undulating, corrugated or sinusoidal, for the continuous carry belt.

16. (canceled)

17. The method of claim 22, comprising periodically lifting one end of the carriage from the rail track as the carriage moves along the rail track to induce the oscillatory motion in the carriage body that is transmitted to the continuous carry belt and bulk material.

18. The method of claim 22, comprising rotatably connecting the wheels to the carriage body by a first axle and a second axle, wherein the first axle is spaced apart from the second axle, and providing the first axle offset or eccentric to the second axle to induce movement of the carriage body, producing the oscillatory motion.

19. The method of claim 22, comprising directing the oscillatory motion at an oblique angle to the continuous carry belt or substantially transverse or orthogonal to the continuous carry belt.

20. The method of claim 22, wherein the frequency of the oscillatory motion is between 2 and 10 Hz, preferably between 3 and 6 Hz, and most preferably between 4 and 6 Hz.

21. The method of claim 22, wherein a peak acceleration of the oscillatory motion is between 1 and 10 m/s², preferably between 4 and 6 m/s², and most preferably at least 6 m/s².

22. A method for reducing moisture in a bulk load being transported by a roller conveyor system having a continuous carry belt to carry the bulk material, the method comprising:
operatively connecting an oscillatory motion assembly to the continuous carry belt, wherein the oscillatory motion assembly comprises a plurality of idler rollers mounted to a first frame or a second frame mounted to a plurality of carriages, each having a carriage body and at least three wheels for engaging a rail track;
supporting the continuous carry belt by the plurality of idler rollers or the second frame; and
arranging a first idler roller offset or eccentric to a second idler to induce an oscillatory motion in the continuous carry belt that is transmitted to the bulk material; or
configuring the at least three wheels to induce an oscillatory motion of the carriage body that is transmitted to the continuous carry belt and the bulk material.
